(19) United States
(12) Patent Application Publication
(10) Pub. No.: US 2011/0145038 A1
(43) Pub. Date: Jun. 16, 2011

(54) Prediction Market Systems and Methods

(76) Inventors: Misha Ghosh, Charlotte, NC (US); Kurt Newman, Matthews, NC (US); David Joa, Irvine, CA (US)

(21) Appl. No.: 12/634,888

(22) Filed: Dec. 10, 2009

(51) Int. Cl. G06Q 10/00; G06Q 30/00; G06Q 40/00; G06Q 50/00; G06F 3/048; G06F 3/01

(52) U.S. Cl. 705/7.32; 705/14.2; 715/777; 715/751

(57) ABSTRACT

The present disclosure provides a method and system for predicting markets, including providing a plurality of prediction questions by an administrator over a network interface, displaying a first screen whereby a user may choose between a plurality of tabs containing a plurality of prediction question topics, displaying a second screen showing the prediction questions, displaying a third screen showing a single prediction question, upon request by a user, and optionally, awarding points to the user.

### FIELD OF THE INVENTION

The present invention relates generally to prediction market systems and method for making predictions of current events.

### BACKGROUND OF THE INVENTION

Prediction markets (also known as predictive markets, information markets, decision markets, idea futures, event derivatives, virtual markets, and the like) are speculative markets created for the purpose of making predictions about anything (sports, politics, current events, financial events, etc.). Assets are created whose final cash value is tied to a particular event (e.g., will the next US president be a Republican) or parameter (e.g., total sales next quarter). The current market prices can then be interpreted as predictions of the probability of the event or the expected value of the parameter. Prediction markets are thus structured as betting exchanges, without any risk for the bookmaker.

Many prediction markets are open to the public. Betfair is the world's biggest prediction exchange, with around $28 billion traded in 2007. Intrade is a for-profit company with a large variety of contracts not including sports. The Iowa Electronic Markets is an academic market examining elections where positions are limited to $500. TradeSports are prediction markets for sporting events. The simExchange, Hollywood Stock Exchange, NewsFutures, the Popular Science Predictions Exchange, Hubdub, The Industry Standard's technology industry prediction market, and the Foresight Exchange Prediction Market are virtual prediction markets where purchases are made with virtual money. Bet2Give is a charity prediction market where real money is traded but ultimately all winnings are donated to the charity of the winner's choice.

### BRIEF SUMMARY OF THE INVENTION

According to an embodiment of the present invention, a method for predicting markets includes providing a plurality of prediction questions by an administrator over a network interface, displaying a first screen whereby a user may choose between a plurality of tabs containing a plurality of prediction question topics, displaying a second screen showing the plurality of prediction questions, displaying a third screen showing a single prediction question, upon request by a user, and optionally, awarding points to the user.

According to another embodiment of the present invention, a method for predicting markets includes providing a login screen, whereby the user may login and access the prediction questions.

According to yet another embodiment of the present invention, a method for predicting markets includes tabs that comprise at least a financial tab, a political tab, and an economic tab.

According to yet another embodiment of the present invention, a method for predicting markets includes displaying a product page for allowing the user to redeem points optionally awarded for products or services.

According to yet another embodiment of the present invention, a method for predicting markets includes displaying a screen under a user tab displaying the total number of points awarded the user.

According to yet another embodiment of the present invention, a method for predicting markets includes displaying a screen rating the top users based upon the optionally awarded points.

According to yet another embodiment of the present invention, a method for predicting markets includes displaying a screen allowing the user to suggest prediction questions.

According to yet another embodiment of the present invention, a method for prediction markets includes providing a plurality of prediction questions by an administrator over a network interface, displaying a screen to the administrator containing a plurality of prediction questions, displaying a screen whereby a user may choose between a plurality of tabs containing a plurality of prediction question topics, displaying a screen showing the prediction questions based upon the requested tab selected by the user, displaying a screen for allowing the user to predict an answer to the plurality of prediction questions, calculation points based upon the answer predicted by the user and optionally awarding points to the user based upon the answer, and adding the optionally awarded points, if any, to a total awarded points total.

According to yet another embodiment of the present invention, a method for prediction markets includes displaying a screen allowing the user to post comments.

According to yet another embodiment of the present invention, a method for prediction markets includes displaying a screen allowing the administrator to monitor comments posted by the user.

According to yet another embodiment of the present invention, a method for prediction markets includes displaying a screen for allowing the user to view RSS feeds.

According to yet another embodiment of the present invention, a method for prediction markets includes displaying a screen for allowing the user to enter identifying information for referring additional users.

According to yet another embodiment of the present invention, a method for prediction markets includes displaying a screen allowing the administrator to view the status of each question and all responses to each question.

According to yet another embodiment of the present invention, a prediction market system, including a local interface, a data store, a processor coupled to the local interface and the data store, wherein the processor is configured to receive a plurality of prediction questions form an administrator over a communications network, display a first screen whereby a user may chose between a plurality of tabs containing prediction question topics, display a second screen showing the prediction questions, display a third screen showing a single prediction questions, upon request by the user, and optionally award points to the user.

According to yet another embodiment of the present invention, the prediction markets system includes a processor configured to display a long screen for allowing a user to provide identifying information.

According to yet another embodiment of the present invention, the prediction markets system includes a processor configured to display a product screen for allowing the user to redeem points optionally awarded for products or services.

According to yet another embodiment of the present invention, the prediction markets system includes a processor configured to display a screen rating the users with the most points.

According to yet another embodiment of the present invention, the prediction markets system includes a processor configured to display a screen allowing users to suggest future questions.

According to yet another embodiment of the present invention, the prediction markets system includes a processor configured to allow the administrator to post prediction questions.

According to yet another embodiment of the present invention, the prediction markets system includes a processor configured to calculate points based upon a predetermined basis involving the accuracy of the answer and the length of time between the date the prediction question is posted to the time the user answers the prediction question.

### BRIEF DESCRIPTION OF THE DRAWINGS

The present invention is illustrated and described herein with reference to the various drawings, in which like reference numbers denote like method steps and/or system components, respectively, and in which:

FIG. 1 is an overview of the predictive market system.

FIG. 2 is a block diagram exemplifying the duties of the administrator.

FIG. 3 is a block diagram outlining the user capabilities in using the system.

FIG. 4 is an exemplary embodiment of the registration interface.

FIG. 5 is an exemplary embodiment of an interface for predicting a question by the user.

FIG. 6 is an exemplary embodiment of an interface utilized by a user for predicting a question.

FIG. 7 is an exemplary embodiment of an interface utilized by the user to subscribe to RSS feeds.

FIG. 8 is an exemplary embodiment of a screen for a blog link.

FIG. 9 is an exemplary embodiment of a top guru rating screen.

FIG. 10 is an exemplary embodiment of a popular prediction area screen.

FIG. 11 is an exemplary embodiment of the check out screen.

FIG. 12 is an exemplary embodiment of a suggest question screen.

FIG. 13 is an exemplary embodiment of a referral screen.

FIG. 14 is an exemplary embodiment of a user management screen

FIG. 15 is an exemplary embodiment of a multiple user management screen.

FIG. 16 is an exemplary embodiment of a user information screen.

FIG. 17 is an exemplary embodiment of a profile screen.

FIG. 18 is an exemplary embodiment of an administrative set-up screen.

FIG. 19 is an exemplary embodiment of a user question screen.

FIG. 20 is an exemplary embodiment of an administrative user question review screen,

FIG. 21 is an exemplary embodiment of an administrative status review screen.

FIG. 22 is an exemplary embodiment of an administrative calculation review screen.

FIG. 23 is an exemplary embodiment of an administrative management screen.

FIG. 24 is an exemplary embodiment of an administrative new item addition screen.

FIG. 25 is an exemplary embodiment of a status review screen.

FIG. 26 is an exemplary embodiment of an administrative review/manage order screen.

### DETAILED DESCRIPTION OF THE INVENTION

In various exemplary embodiments, the present invention provides a website, a network, algorithms, a series of servers, a management system, and the like to support an implementation of predictive market systems and methods with the main processes described below. Such website, network, algorithms, servers, and management system collectively provide gaming and competition systems and methods where registered users answer questions in different categories such as economics, financial, political, and the like in different questions posed by the site. The corresponding answers provide a framework for a predictive market. Further, the present invention includes various algorithms to improve the predictions by rewarding successful answers, correlating answers between users, and the like.

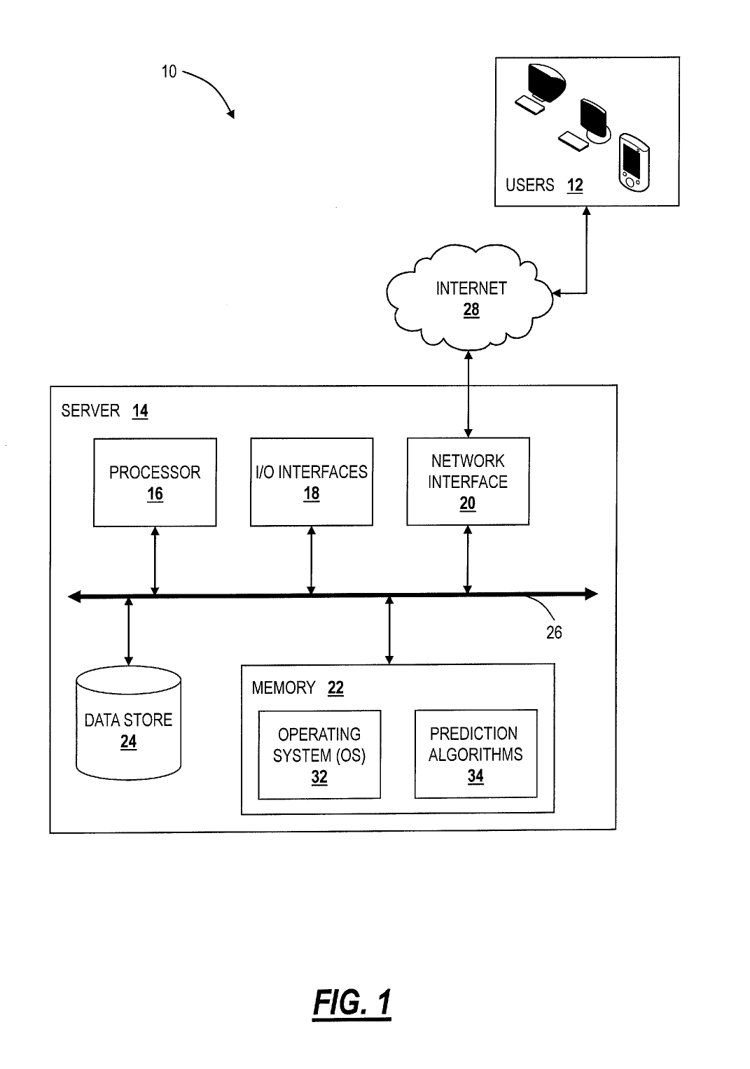

Referring to FIG. 1, a predictive system 10 is illustrated for allowing a plurality of users 12 to access a server 14 for making predictions and the like according to an exemplary embodiment of the present invention. The server 14 can be a digital computer that, in terms of hardware architecture, generally includes a processor 16, input/output (I/O) interfaces 18, a network interface 20, memory 22, and a data store 24. The components (16, 18, 20, 22, and 24) are communicatively coupled via a local interface 26. The local interface 26 can be, for example but not limited to, one or more buses or other wired or wireless connections, as is known in the art. The local interface 26 can have additional elements, which are omitted for simplicity, such as controllers, buffers (caches), drivers, repeaters, and receivers, among many others, to enable communications. Further, the local interface 26 can include address, control, and/or data connections to enable appropriate communications among the aforementioned components.

The processor 16 is a hardware device for executing software instructions. The processor 16 can be any custom made or commercially available processor, a central processing unit (CPU), an auxiliary processor among several processors associated with the server 14, a semiconductor-based microprocessor (in the form of a microchip or chip set), or generally any device for executing software instructions. When the server 14 is in operation, the processor 16 is configured to execute software stored within the memory 22, to communicate data to and from the memory 22, and to generally control operations of the server 14 pursuant to the software instructions.

The I/O interfaces 18 can be used to receive user input from and/or for providing system output to one or more devices or components. User input can be provided via, for example, a keyboard and/or a mouse. System output can be provided via a display device and a printer (not shown). I/O interfaces 18 can include, for example, a serial port, a parallel port, a small computer system interface (SCSI), an infrared (IR) interface, a radio frequency (RF) interface, and/or a universal serial bus (USB) interface.

The network interface 20 can be used to enable the server 14 to communicate on a network, such as the Internet 28. For example, the server 14 can utilize the network interface 20 to communicate to multiple users 30 over the Internet 28. The users 30 can include desktop computers connected to the Internet 28 via a high-speed connection (DSL, Cable modem, WiMax, Cellular, etc.), laptop computers connected to the Internet 28 via the high-speed connection, mobile devices connected to the Internet 28 via a mobile network, and the like. Each user 30 can also include a network interface to communicate to the server 14. The network interface 20 can include, for example, an Ethernet card (e.g., 10BaseT, Fast Ethernet, Gigabit Ethernet) or a wireless local area network (WLAN) card (e.g., 802.11a/b/g). The network interface 20 can include address, control, and/or data connections to enable appropriate communications on the network.

A data store 24 can be used to store data. The data store 24 can include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 24 can incorporate electronic, magnetic, optical, and/or other types of storage media. In one example, the data store 24 can be located internal to the server 14 such as, for example, an internal hard drive connected to the local interface 26 in the server 14. Additionally in another embodiment, the data store can be located external to the server 12 such as, for example, an external hard drive connected to the I/O interfaces 18 (e.g., SCSI or USB connection). Finally in a third embodiment, the data store 24 may be connected to the server 12 through a network, such as, for example, a network attached file server.

The memory 22 can include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof Moreover, the memory 22 may incorporate electronic, magnetic, optical, and/or other types of storage media. Note that the memory 22 can have a distributed architecture, where various components are situated remotely from one another, but can be accessed by the processor 16.

The software in memory 22 can include one or more software programs, each of which includes an ordered listing of executable instructions for implementing logical functions. The software in the memory system 22 includes the adaptive gain control 14 engine and a suitable operating system (O/S) 32. The operating system 32 essentially controls the execution of other computer programs and provides scheduling, input-output control, file and data management, memory management, and communication control and related services. The operating system 28 can be any of Windows NT, Windows 2000, Windows XP, Windows Vista (all available from Microsoft, Corp. of Redmond, Wash.), Solaris (available from Sun Microsystems, Inc. of Palo Alto, Calif.), LINUX (or another UNIX variant) (available from Red Hat of Raleigh, N.C.), or the like.

The predictive system 10 allows a user 100 to predict future events and participate in gaming. The predictive system 10 includes two major functions. The first function is that of a user 100, and the second function is that of an administrator 102. The function of the user 100 and administrator 102 will be explained in detail below. Generally, the predictive system 10 allows a user 100 to predict future events based upon questions or topics supplied by the administrator 102. Preferably, the future events fall into three categories: 1) Economic, 2) Financial, and 3) Political. The user 100 predicts future events based upon these three categories, and the user 100 may obtain points based upon a predetermined system. These points may be redeemed for products and merchandise utilizing a shopping cart application.

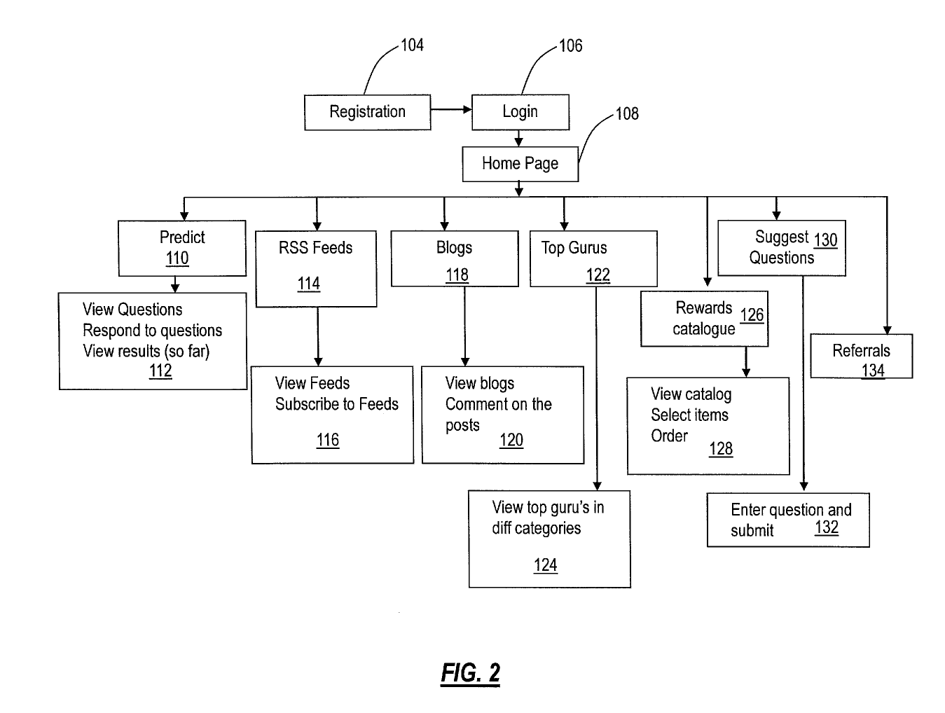

As illustrated in FIG. 2, the user 100 will have the following functions:
Register (CASS Validation of address)
Login
Edit profile
View prediction questions and respond
View blogs and comment on topics
View RSS feeds displayed on Home Page
Subscribe to RSS feeds
View TopGurus
View Rewards Catalogue
Order Rewards Catalogue items redeeming points
Suggest Questions
Referrels

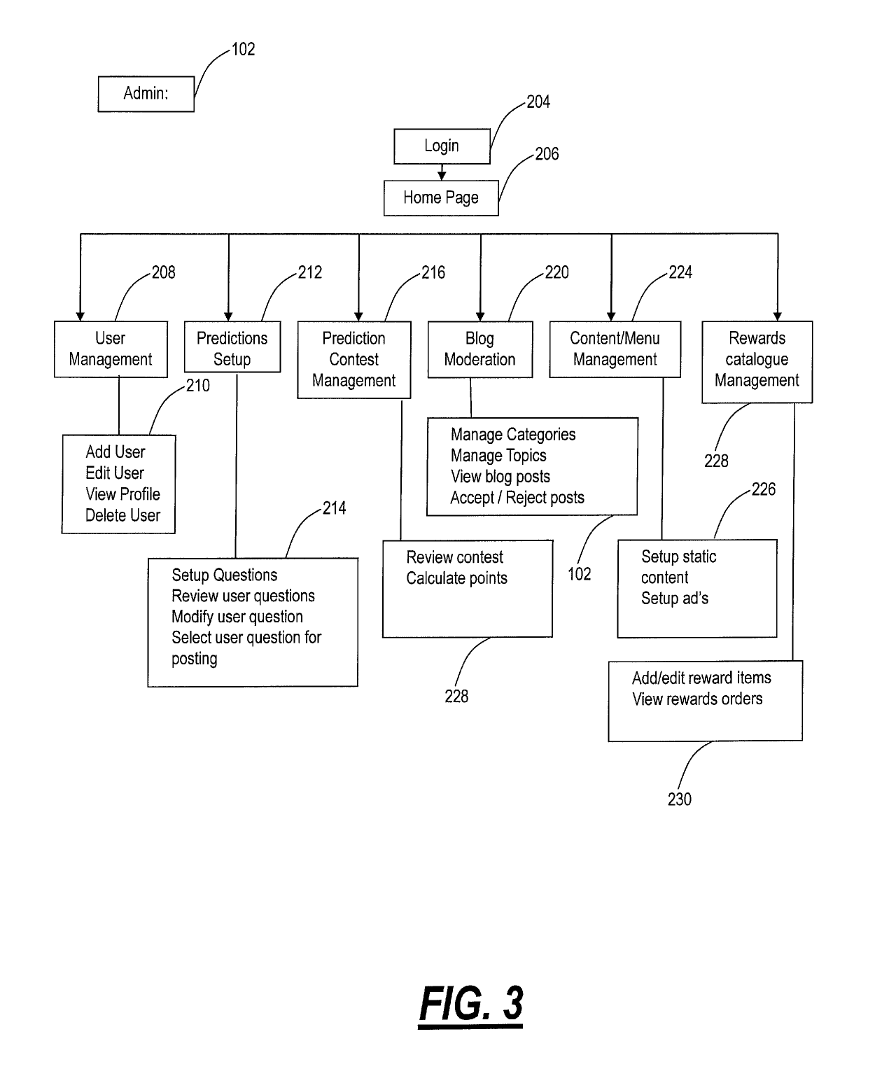

As illustrated in FIG. 3, the administrator 102 will have the following functions:
User management
Content/Menu management
Predictions management
Blogs moderation
Creation of RSS Feeds, ability to subscribe RSS Feeds by other websites
TopGurus in each section as Financial, Policitcal, and Economic
Rewards Catalogue Management

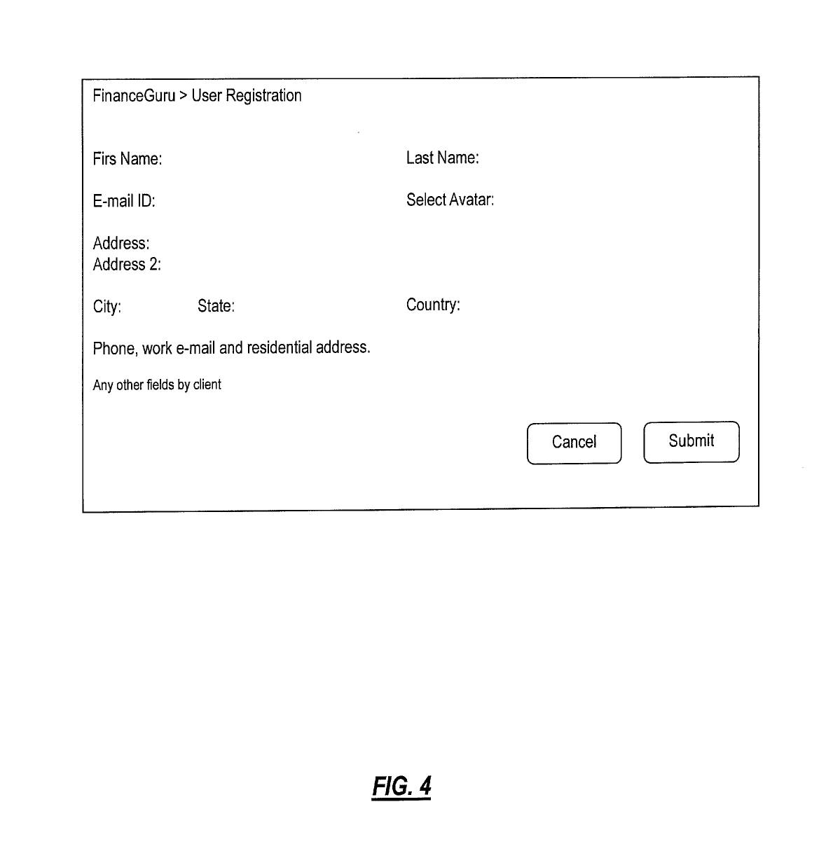

The user 100 first must register 104 by completing the registration process, utilizing a registration interface as illustrated in FIG. 4. The user 104 may register by entering their first name, last name, email address, a primary address, a secondary address, an avatar, a phone, a work email, and any other information the user 100 desires to submit during the registration process. Prior to saving the data entered by the user 100 into the database, the email address will be validated using a CASS system. Once the email address is verified by the user, the data is entered into the database. The predictive system 10 tracks the IP and stores in the database for determining the location of the user 100 for data collection purposes.

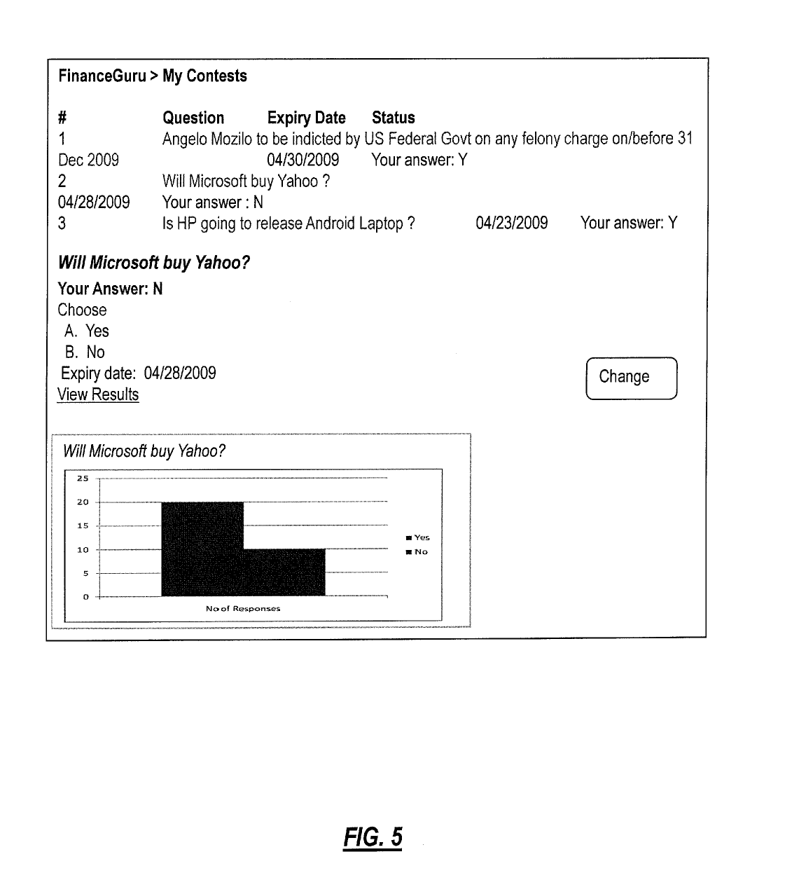

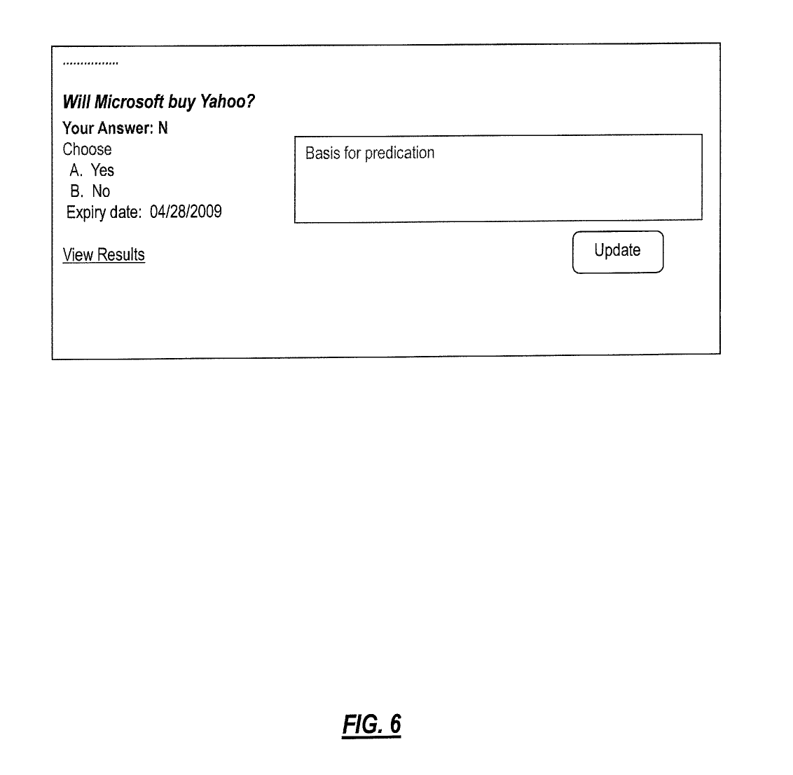

Once the user 100 is registered, the user 100 may login 106 to the predictive system. The login 106 will consist of the user 100 entering a user name and password to access the system or other identifying information. Once the user 100 has completed the information for the login 106, the user 100 is directed to a homepage 108 of the predictive system 10. The homepage 108 will consist of a plurality of tabs, preferably 4 tabs, in the prediction section 110, including a financial tab, a political tab, an economic tab, and a user tab. Alternatively, the homepage may include a hodgepodge tab, including a mix of financial, economic, political, and a Xpert perspectives tab. The financial tab, political tab, Xpert perspectives, hodgepodge, and economic tab will be displayed to all users, but the user tab will only be displayed once a user logs into the website. The user 100 may view the questions 112 for prediction. The user 100 may click on a predict link and will be directed to a screen such as that in FIG. 5. The user 100 may select the question the user 100 desires to predict. An exemplary screen is illustrated in FIG. 6. The tabs will have a prediction question sorted by the number of users predicated for it. In the case of the Xpert Perspectives tab, a brief synopsis of an expert's opinion concerning a subject matter is provided with a link to a full article or more information. If the number of questions are more than 5 pages, the paging will be activated automatically in the bottom. Under the user tab, the tab will consist of all questions that have been predicted or answered by the user 100. The tab will also contain the total number of points awarded to the user 100 and a link to a product page. The user 100 may be directed to the product page to redeem points awarded.

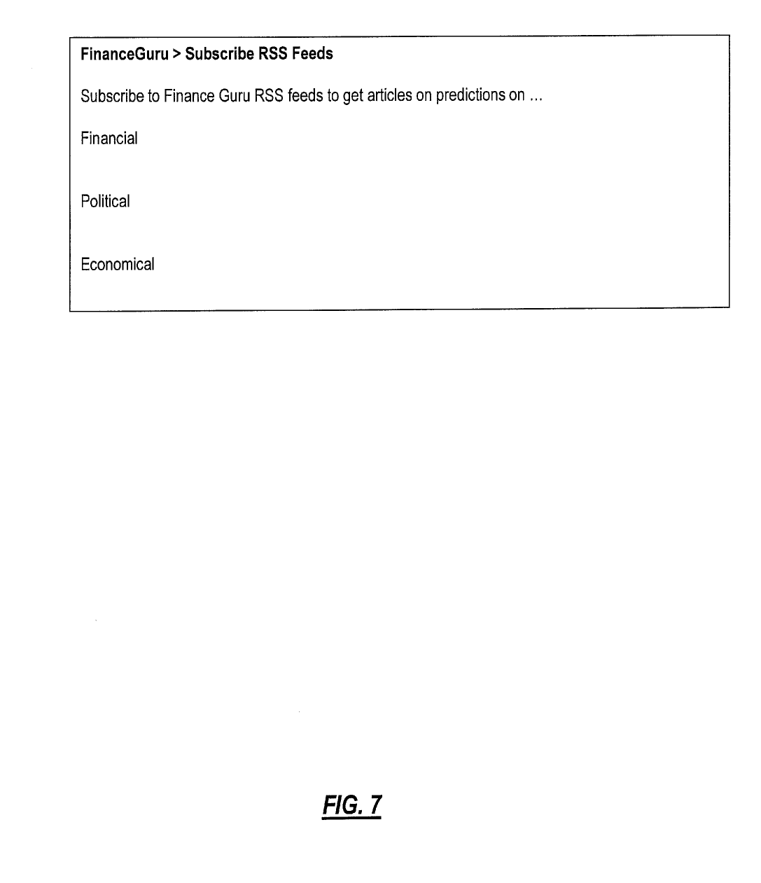

The predictive system 10 may also consist of RSS Feeds 114 section. This section allows the user 100 to view RSS feeds 114 and to subscribe to such feeds. For subscribing to RSS Feeds 114, the user 100 may select the RSS Feeds 114 link and the screen illustrated in FIG. 7 is presented to the user 100. The RSS Feeds 114 allow the user to view market news, political news, and the like.

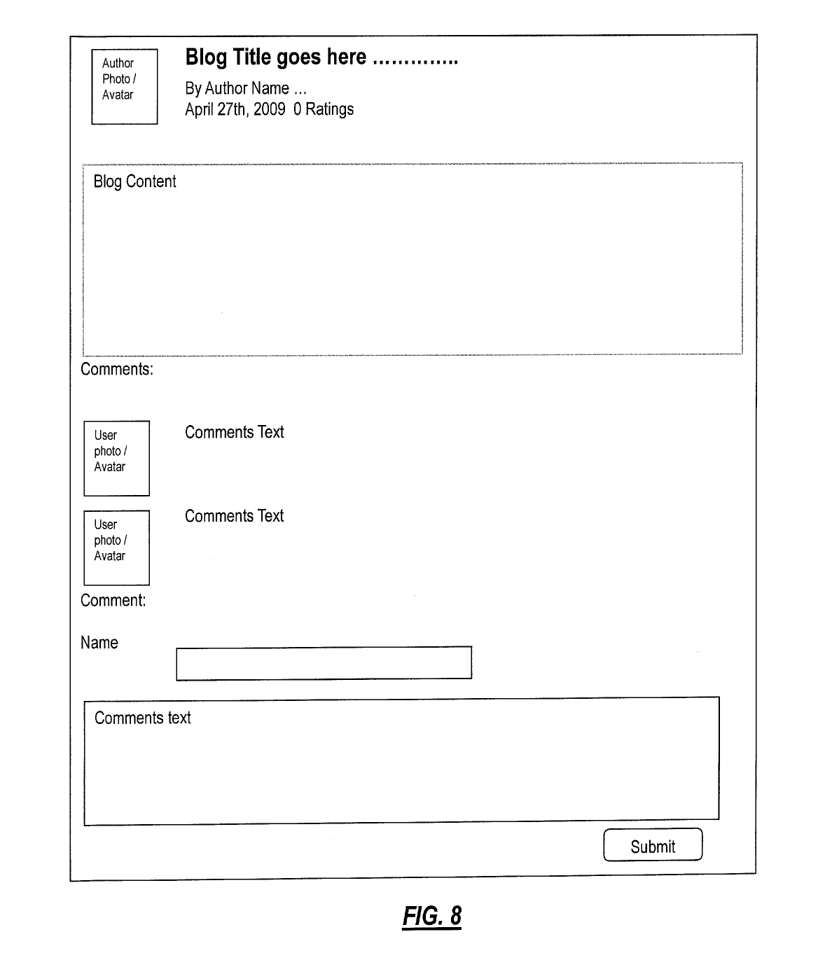

A blog section 118 may be incorporated into the prediction system 10. The blog section 118 allows the user 100 to interact with other users 120 by viewing blogs, posting comments on the blog, and responding to comments posted by other users 100. The user 100 may click on a blog link, and a screen, such as that illustrated in FIG. 8, appears for the user to view blogs, post comments on the blog, and respond to comments posted by other users 100.

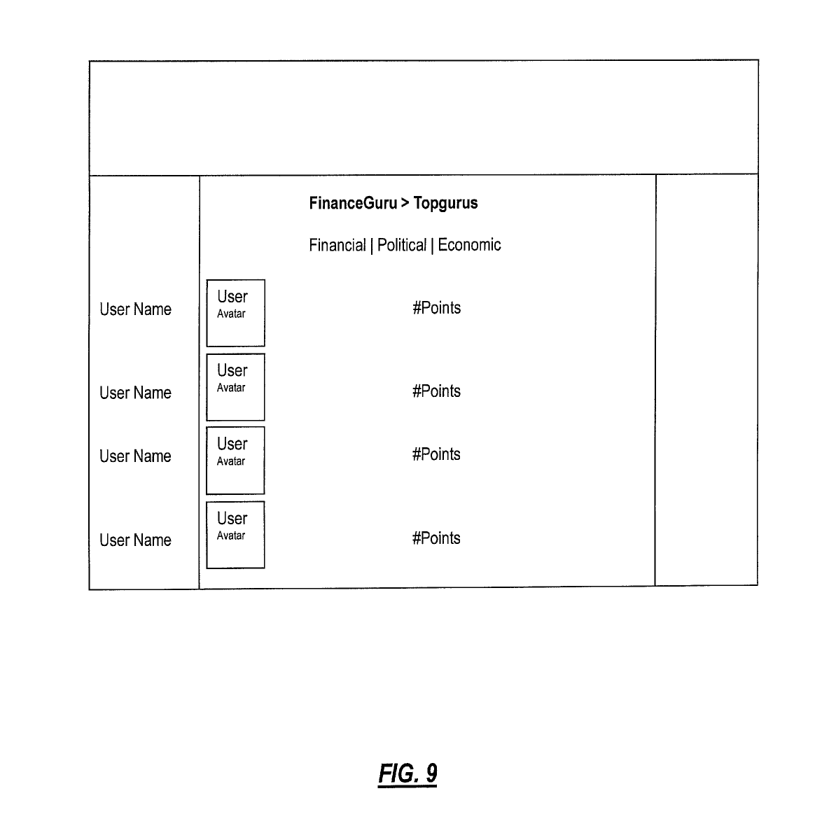

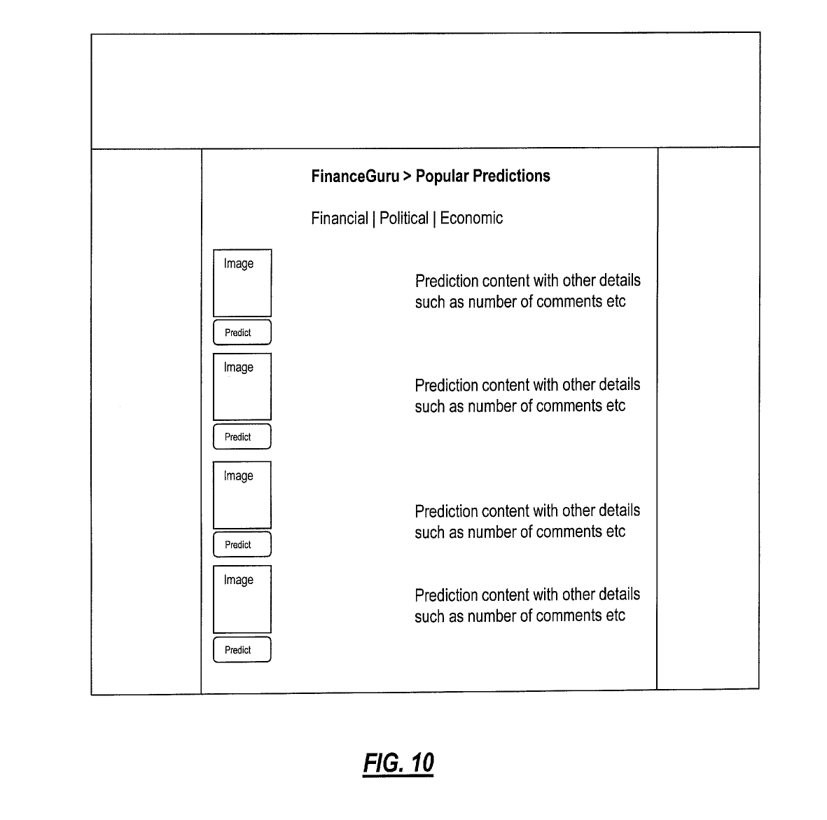

A top guru 122 section provides a boost to the user's ego by ranking users based upon the points awarded to them. The predictive system 10 allows the user 100 to view the top gurus in each respective category on a ranking page 124. The ranking page 124, as illustrated in FIG. 9, will include tabs for each market or category (financial, political, economic, or hodgepodge). The user 100 may select a tab, whereby they are directed to a screen where all the users with points are arranged in a predetermined order. For example, the users may be arranged from the user 100 with the highest number of points to the user 100 with the lowest number of points. Additionally, the user 100 may access a popular prediction area screen, as illustrated in FIG. 10. The popular prediction area screen is a list of all popular predictions by category.

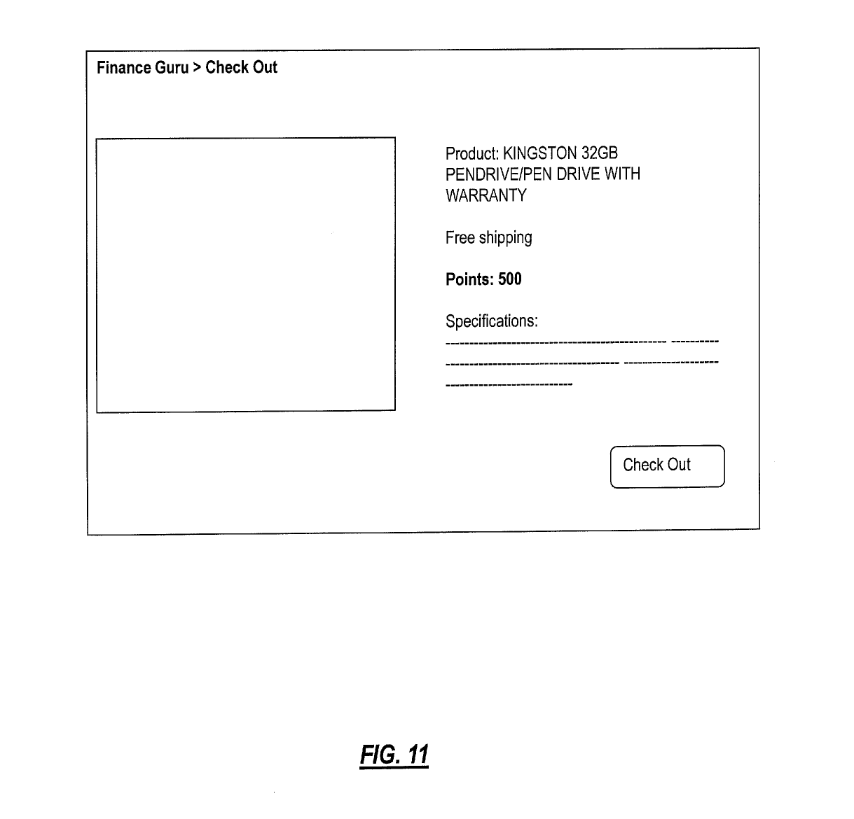

The predictive system 10 includes a coveted rewards catalogue 126 where users 100 can redeem their points for merchandise. Once the user 100 has accessed the rewards catalogue 126, the user can view the entire contents of the catalogue 126, select items from the catalogue 126 that correspond with the points accumulated, and order the items 128. Preferably, the rewards catalogue 126 utilizes a shopping cart feature that is well known in the art. This feature allows the user 100 to select an item and then are presented with the option of continuing to shop. The user 100 may opt to continue to shop or to checkout. Once the user 100 opts to checkout, a new page will appear such as the screen illustrated in FIG. 11. The user 100 confirms the item or items selected from the catalogue 126, and confirms the shipping address.

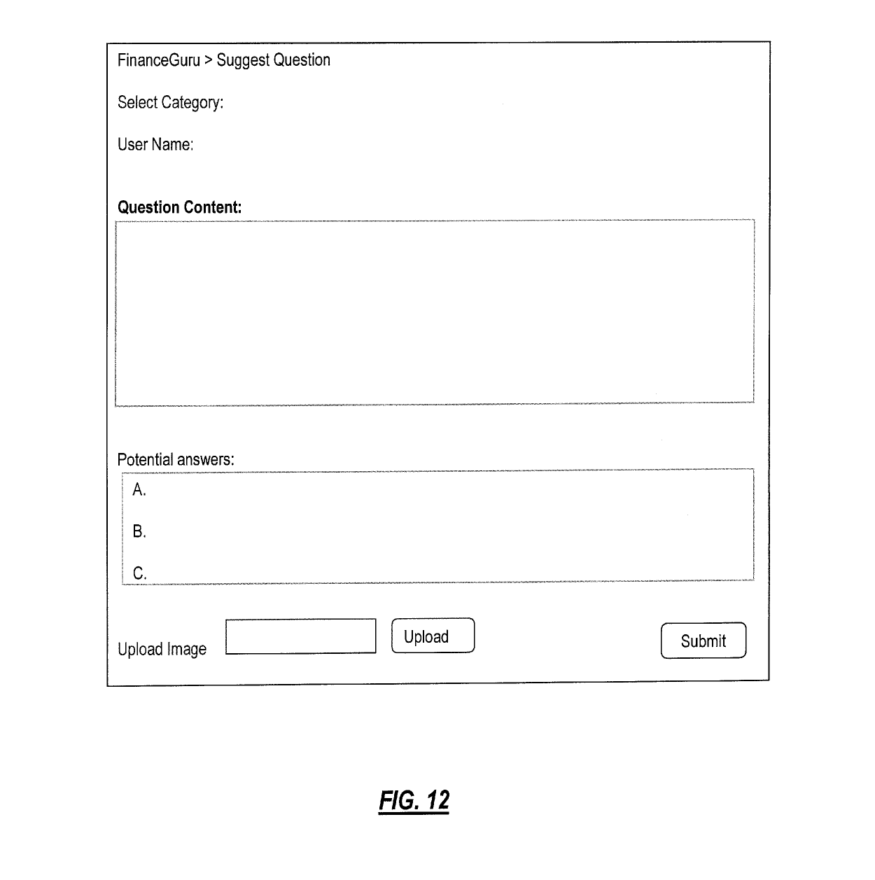

The predictive system 10 allows a user 100 to suggest future questions 130. If the user desires to submit a suggestion for a future question or future topic, the user 100 clicks the suggest question link and is directed to enter the question and submit the question 132 to the administrator on a screen such as that illustrated in FIG. 12. Once the question is submitted, an email notification is sent to the administrator. The administrator may login to the system and approve the question to show on the predictive system 10 under a suggested question session available for viewing by fellow users.

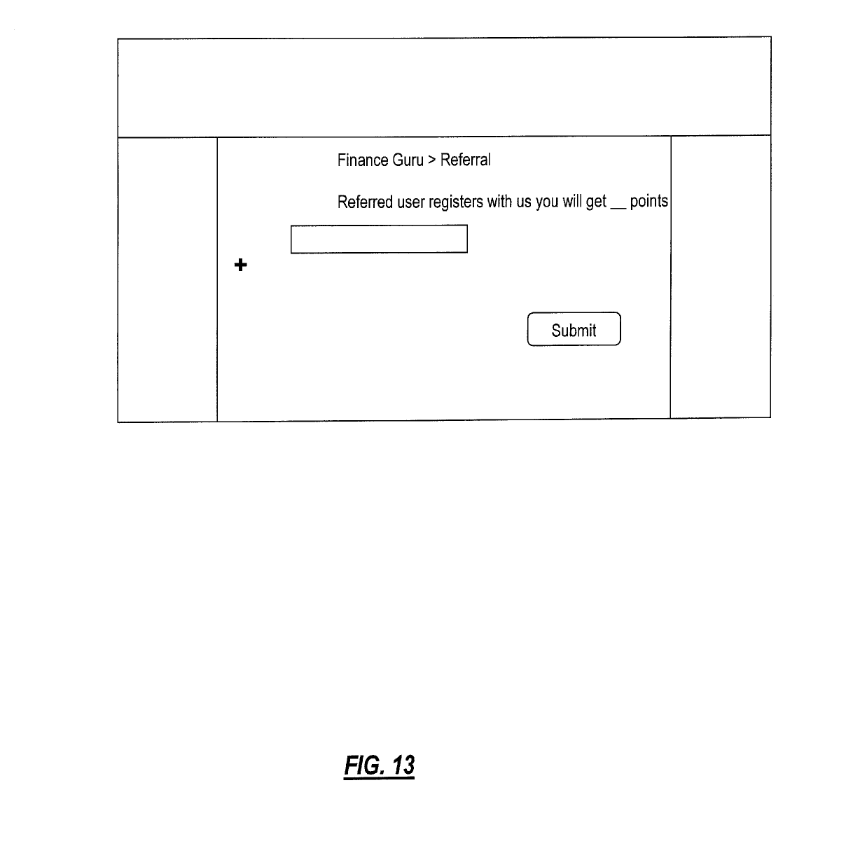

The user 100 may also enter referrals 134. The user 100 may click on a link for referrals, and the predictive system 10 will ask the user 100 for the referral's email address. This page is illustrated in FIG. 13. The predictive system 10 will track the entered email address to determine if the email address registers with the predictive system 10. If the email address registers, the user 100 will receive points as a reward for the referral.

In a preferred embodiment, the homepage contains a banner titled “tweets.” This banner allows the user to access a message board with short statements pertinent to the predictive system 10, including a link that would provide more information on a separate webpage.

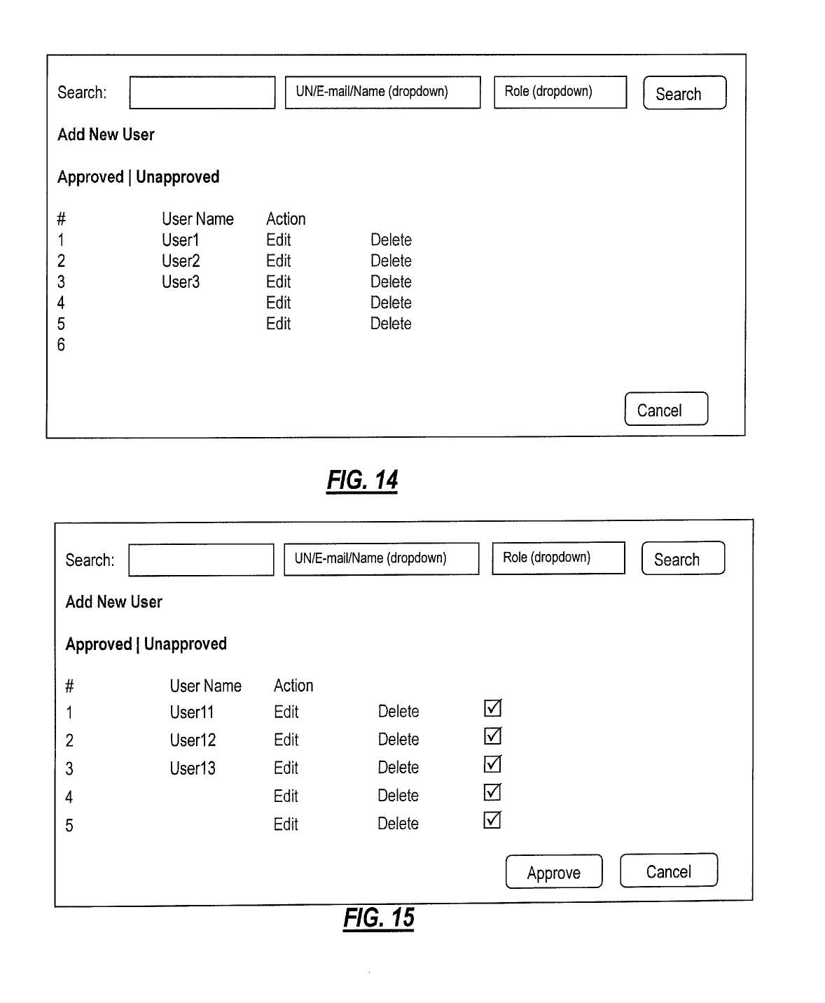

The administrator 102 function of the predictive system 10 is to monitor usage and insure the predictive system 10 runs smoothly, efficiently, and effectively. The administrator 102 must login by the administrator login 204 and is directed to the administrative homepage 206. From the administrative homepage 206 the administrator 102 can access the user management link 208. User management 208 allows the administrator 102 to add users for only site staff, edit users, view user profiles, and delete users 210. The screen shown in FIG. 14 is for user management and the screen shown in FIG. 15 is used for multiple user approval. Users 100 are added through an online registration process, as described above. When the user 100 registers, an email notification is sent to the administrator regarding the new registration. The administrator 102 is allowed to approve the individual user 100 or approve a batch of users at one time. Once the administrator 102 has approved the user 100, an automatically generated email will be sent to the user 100 with a login link to the website so the user 100 may access the predictive system 10.

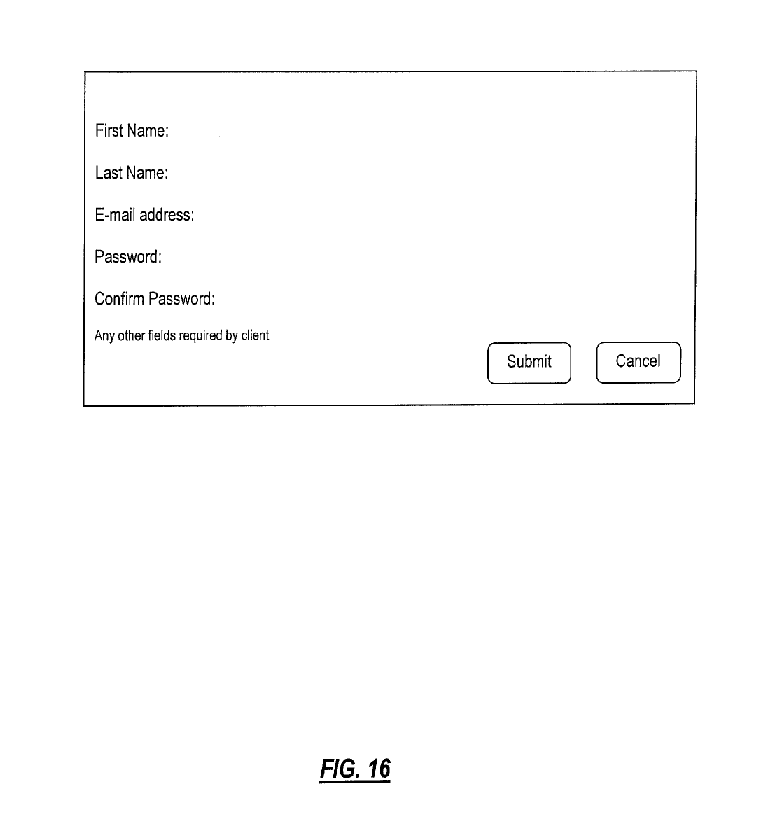

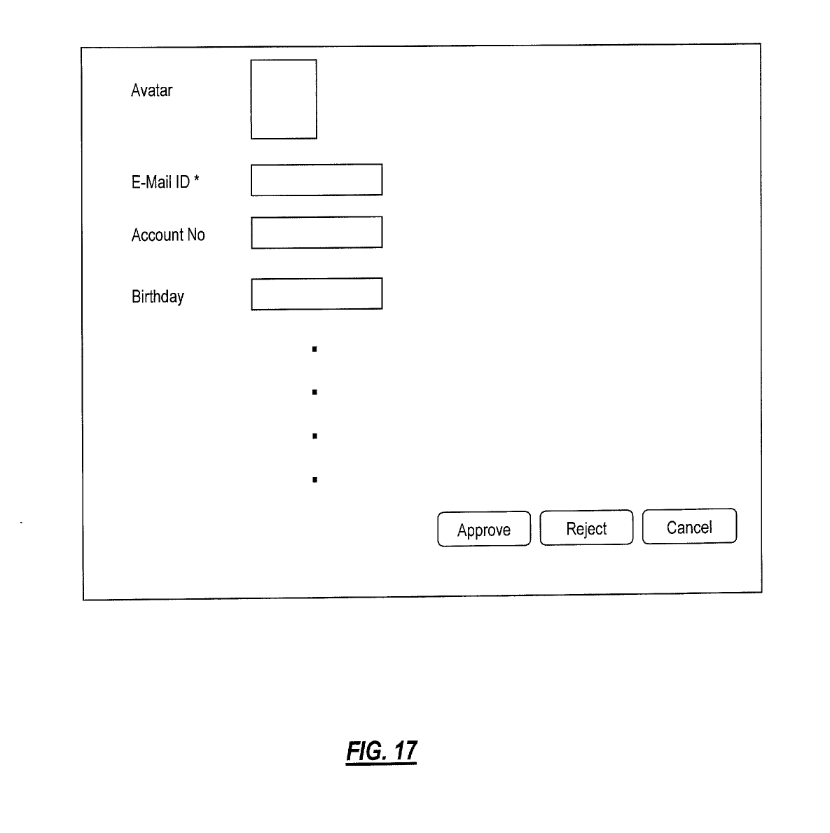

The administrator 102 may add a user 100 to the predictive system 10 without requiring the user 100 to register online. The administrator 102 sets up the user 100 by entering the user's contact information, such as name and email address on an screen as shown in FIG. 16. The administrator 102 also sets a password for the user 100 that may be changed by the user 100, once the user 100 logs into the predictive system 10. The administrator 102 may click on a user name that is presented on a grid list of users 100 to view or edit the profile of the user 100. A profile screen that would be available to the administrator is illustrated in FIG. 17. The administrator 102 can view the avatar (to ensure the avatar is appropriate), the email id, account number, birthday, and the like.

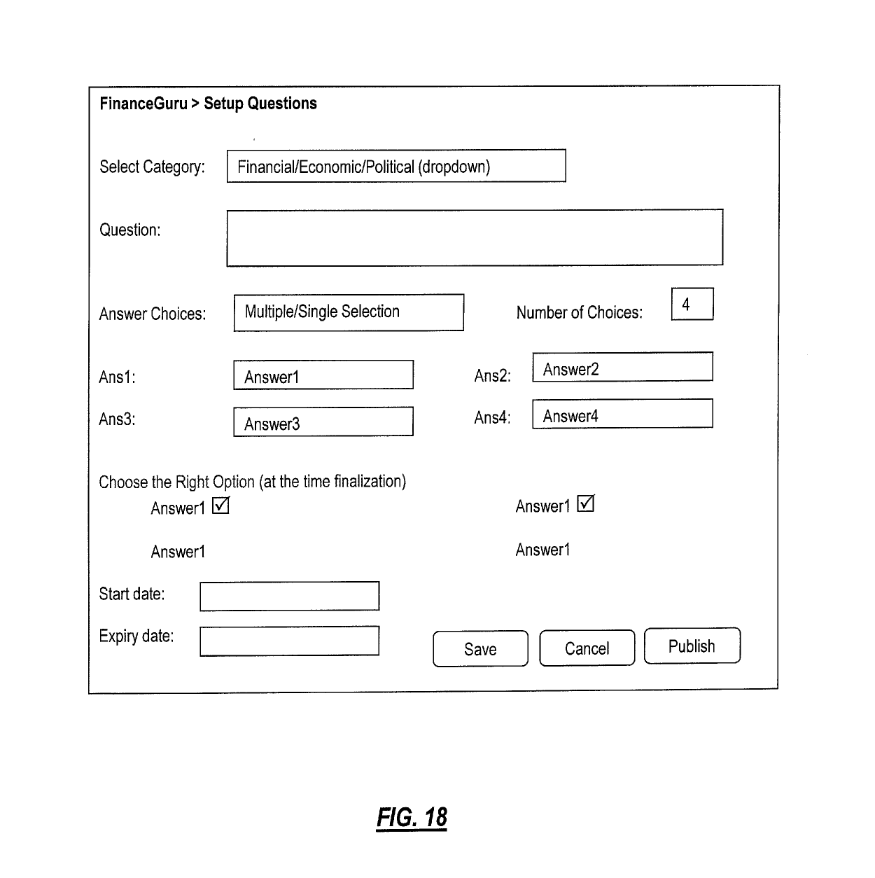

The main function of the administrator 102 is to set up predictive questions 212. The predictive questions are grouped into the financial, economic or political categories, allowing a user 100 to choose the category he is most interested in predicting. The administrator 102 sets up the question for the contest to determine the appropriate category for the question. The administrator 102 sets an expiration date and time, on which users 100 are not allowed to submit any more predictions. A screen the administrator 102 uses to set up the questions is illustrated in FIG. 18.

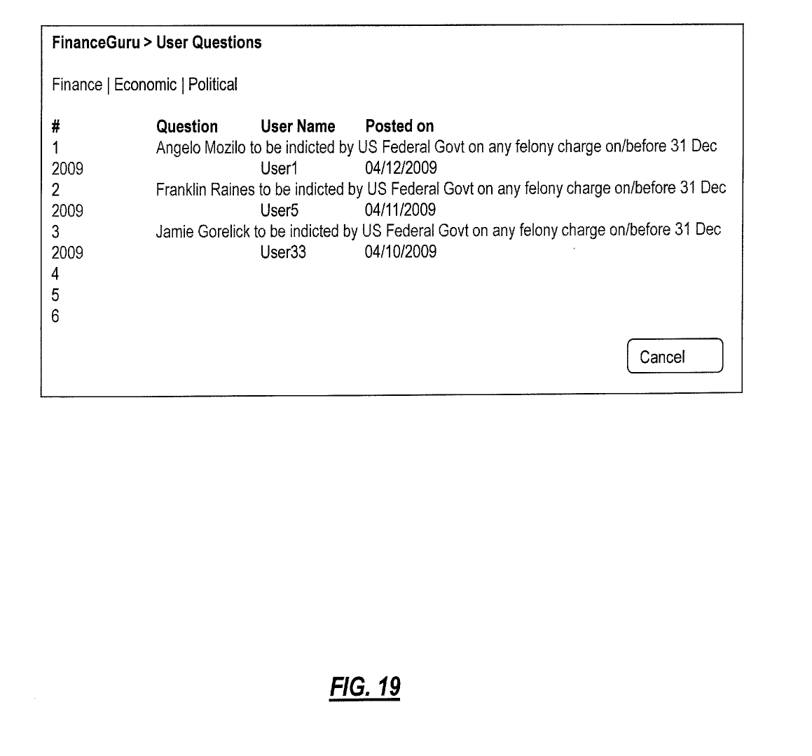

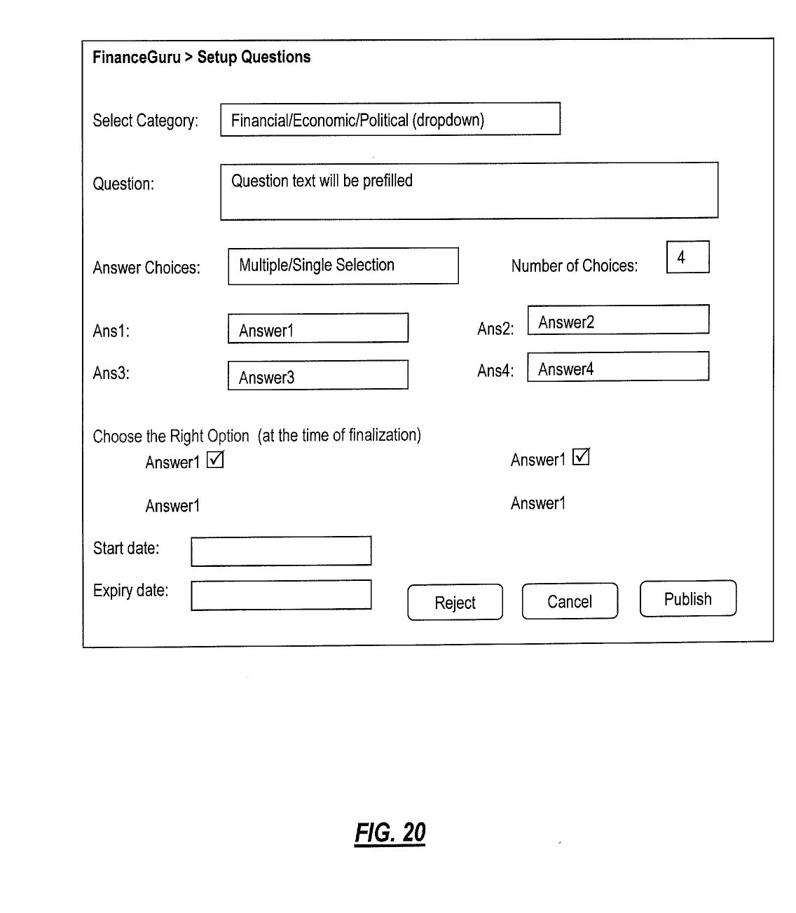

The questions posted by the user 100 will be displayed to the administrator by category in different tabs, as illustrated in FIG. 19. The administrator 102 is able to view the question, the actual user 100 that posted the question, and the date the user 100 posted the question (214). The administrator 102 also has the ability to make changes to the question, reject the question, and/or publish the question for other users 100 to predict (214). By clicking on the questions posted by the user 100, the interface shown in FIG. 20 will be available for the administrator 102. This interface allows the administrator to make any necessary changes to the question, reject the question, or publish the question.

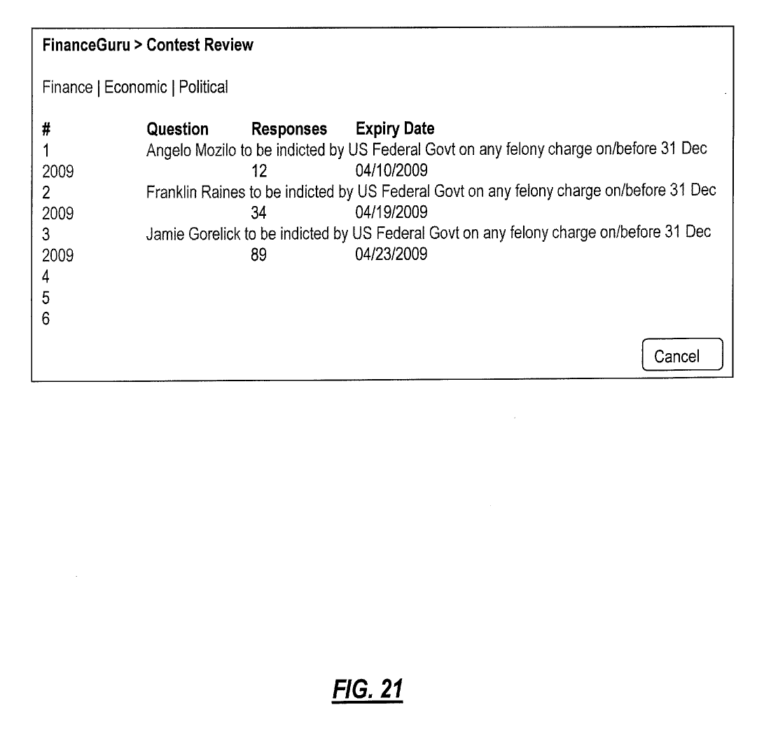

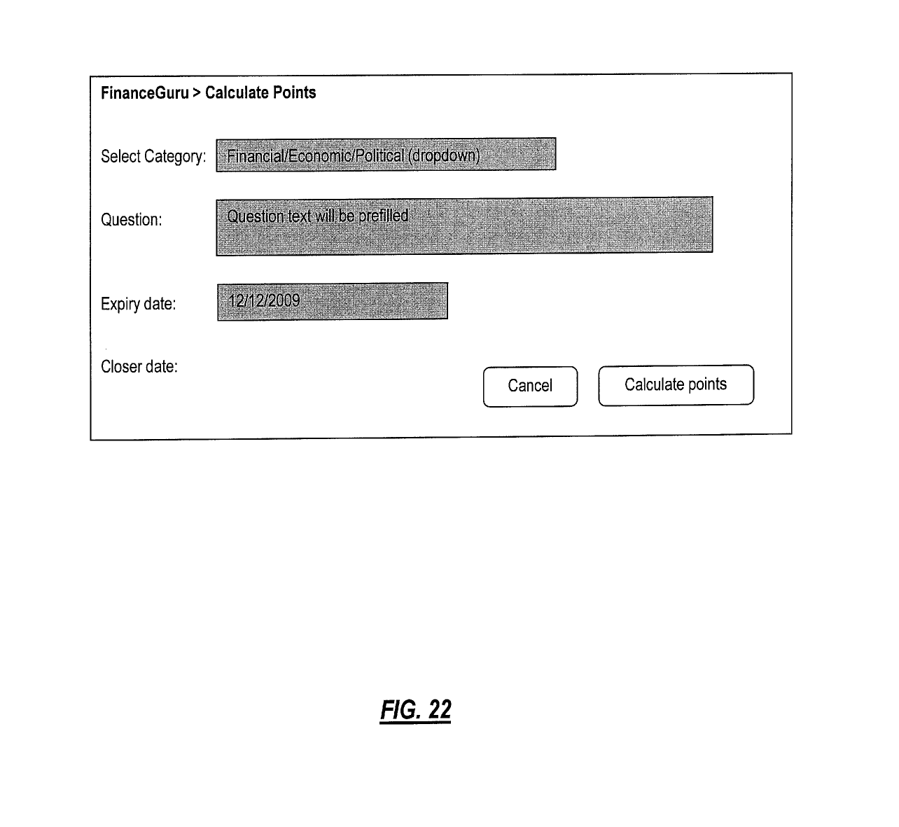

The administrator 102 manages the prediction contest (216), including composing questions for users 100 to predict. The administrator 102 is able to view the status of each question and responses as a single, comprehensive list, as illustrated by the screen of FIG. 21. The administrator 102 has the capability of reviewing any and all questions for managing the prediction contest and calculate points (218) by utilizing the screen shown in FIG. 22. The administrator 102 is able to monitor the expiration date of each prediction question, and if the expiration date has passed, the administrator 102 may finalize the question. Once the administrator 102 finalizes the question, the predictive system 10 calculates the points to be awarded for the users 100 based upon the prediction as compared to the actual answer. The total scores of the users 100 are then updated to reflect the points gained from participation in the question.

The administrator 102 will post the contest questions the first day of every quarter, requiring users 100 to register prior to the start of the quarter. The users 100 may register and predict a question at any period within the quarter. The first day of the quarter is the most rewarding day and the time when the most points are awarded for a question. If the user 100 predicts a question on the first day and the prediction is correct, the user will be assigned 500 points, for example. Every day after the first day of the quarter, the user 100 is assigned points proportionately based upon the length of time from the date the answer is submitted and the start of the quarter.

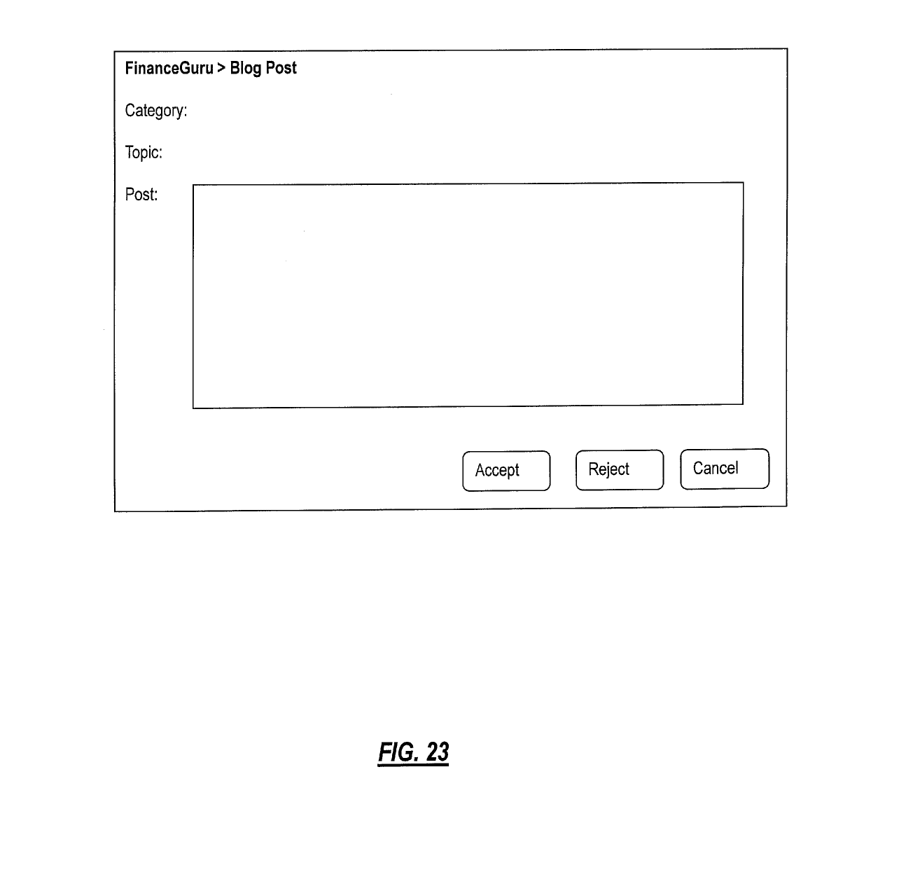

The administrator 102 also has the ability to manage the user blog 220. The administrator 102 is able to manage categories, manage topics, view blog posts, accept posts, and reject posts (222) using a screen as illustrated in FIG. 23. The blog posts are comments posted by users 100 about discussion topics. The administrator 102 is able to view the blog posts and approve blog posts prior to public viewing. The administrator 102 is alerted as to a blog post by an automatically generated email, providing the administrator 102 with details such as the topic and category of the blog post. The posts are provided to the administrator 102 prior to being displayed to the user 100. The administrator 102 has the interface to accept/reject the blogs posted by a user 100.

The administrator 102 manages the static site content and menu management 224. The menu management 224 allows the administrator 102 to setup static content and setup ads 226. Ads can be managed by a banner/ad management interface that is known in the industry.

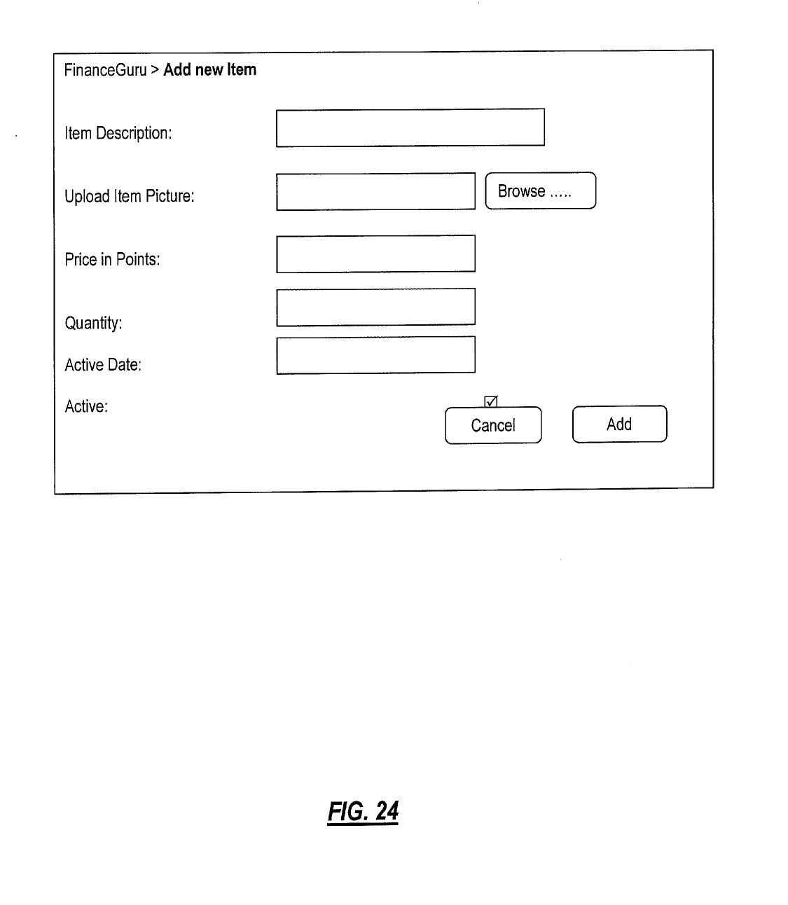

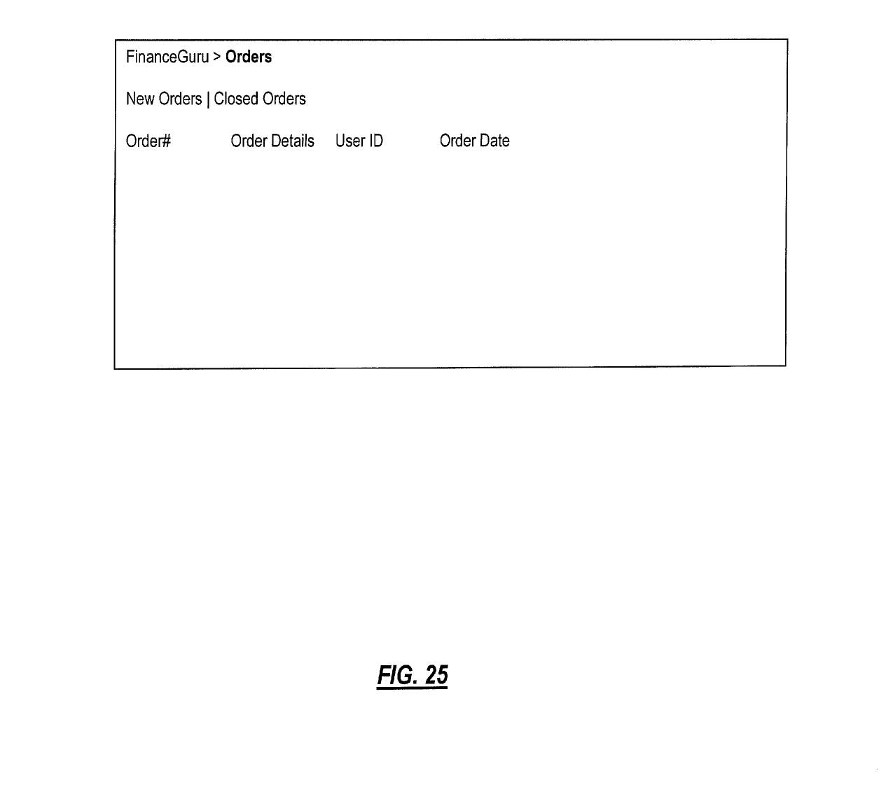

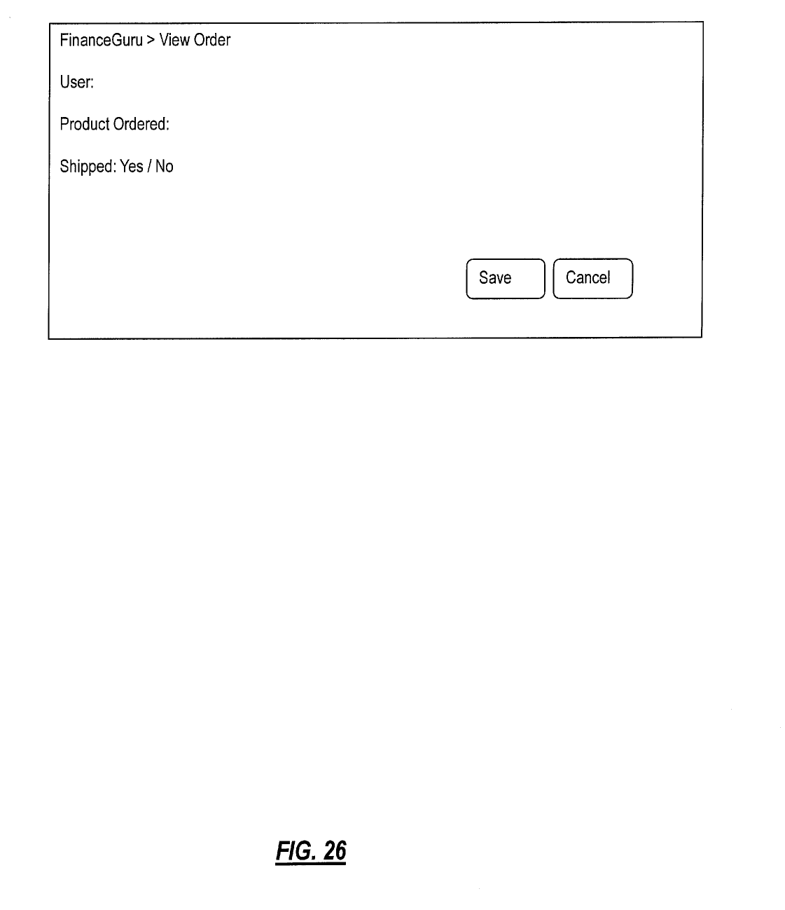

The administrator 102 also manages the rewards catalogue 228. The rewards management 228 allows the administrator 102 to add/edit reward items and view reward orders 230. The rewards management 228 allows the administrator 102 to manage the items that may be redeemed in exchange for reward points earned by the users 100. The predictive system 10 allows the administrator to configure items with corresponding images, price (i.e. the number of points needed to redeem in exchange for item), etc. The administrator 102 can add new items utilizing the screen illustrated in FIG. 24. The administrator 102 can view the status of orders placed by users 100 (utilizing the interface shown in FIG. 25) and review/manage such orders (utilizing the interface shown in FIG. 26).

In an alternative embodiment, the user 100 is directed to a homepage 108 of the predictive system 10. The homepage 108 will consist of a plurality of tabs, representing industries within the economy, such as financial services, media, retail, transportation, technology, lodging, real estate, user and the “catch-all” others. These tabs will be displayed to all users, but the user tab will only be displayed once a user logs into the website. A tab titled “our 2 cents” is available to review news stories relevant to the industries indicated by the tabs. The user 100 may view the questions 112 under the industry specific tabs for predicting questions about a specific company within the industry. For example, the prediction questions posed to the user 100 may be related to the viability of the company and probability the company will regain market share or retain their consumer base and the like. The user 100 may click on a predict link, wherein the user 100 may select an answer. If the number of questions are more than 5 pages, the paging will be activated automatically in the bottom. Under the user tab, the tab will consist of all questions that have been predicted or answered by the user 100. The tab will also contain the total number of points awarded to the user 100 and a link to a product page. The user 100 may be directed to the product page to redeem points awarded.

In another alternative embodiment of the present invention, the user 100 may be a plurality of students and professors from multiple universities. During the registration process, the system 10 will ensure the students and professors are indeed affiliated with a university. This can be accomplished by verifying the email address of the students and professors have a .edu in their email address. The student and professor will register as either a student or professor. A drop down menu will be available, whereby the student and professor can select the university or college they represent. The scores will grouped among the students and professors and the total score for the university or college will be displayed. In yet another alternative embodiment, individual companies or government agencies may be pitted against one another utilizing the system 10.

In yet another alternative embodiment of the present invention, the points may be awarded based upon odds. For example, the user 100 will make a prediction about whether or not a company is likely to file bankruptcy. If the company is solvent and bankruptcy appears unlikely, the user 100 would receive an additional points for making a prediction whose outcome appears unlikely. The odds associated with such a prediction could be measured at 3:1; 4:1, etch. However, if the user 100 is incorrect, points may be subtracted from the user 100.

In yet another alternative embodiment of the present invention, the predictive markets system may include an investments option. The users 100 will experiment with market conditions without risking their money. The user 100 is awarded free points, and may invest the points based upon the questions predictive questions 112 presented. The user 100 may also buy, put, or call options using their points to enhance the investment feel of the game. Once the user 100 accumulates a predetermined amount of points in excess of the free points, they can redeem the accumulated points for items in the rewards catalogue 126. The market conditions associated with the predictive questions 112 may be based upon a simulated or real market condition. The simulated market conditions will be established by the administrator 102. Under real market conditions, real market data applies, even trading systems, but instead of the trading system interfacing with actual brokers to enter trades in the “real” market, the trading system simply enters “simulated” trades into a completely contained market simulation. The return on investment is based on actual market movements. Stocks, bonds, ETFs, mutual funds, commodities, and the like may be simulated based upon the real market.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention and are intended to be covered by the following claims.

What is claimed is:

1. A method for predicting markets, comprising:
providing a plurality of prediction questions by an administrator over a network interface;
displaying a first screen whereby a user may choose between a plurality of tabs containing a plurality of prediction question topics;
displaying a second screen showing the plurality of prediction questions;
displaying a third screen showing a single prediction question, upon request by a user; and
optionally, awarding points to the user.

2. The method according to claim 1, further comprising providing a login screen, whereby the user may login and access the prediction questions.

3. The method according to claim 1, wherein the tabs comprise at least a financial tab, a political tab, and an economic tab.

4. The method according to claim 1, further comprising displaying a product page for allowing the user to redeem points optionally awarded for products or services.

5. The method according to claim 1, further comprising displaying a screen under a user tab displaying the total number of points awarded to the user.

6. The method according to claim 1, further comprising displaying a screen rating the top users based upon the optionally awarded points.

7. The method according to claim 1, further comprising displaying a screen allowing the user to suggest prediction questions.

8. A method for predicting markets, comprising:
providing a plurality of prediction questions by an administrator over a network interface;
displaying a screen to the administrator containing the plurality of prediction questions;
displaying a screen whereby a user may choose between a plurality of tabs containing a plurality of prediction questions topics;
displaying a screen showing the prediction questions based upon the requested tab selected by the user;
displaying a screen for allowing the user to predict an answer to the plurality of prediction questions;
calculating points based upon the answer predicted by the user and optionally awarding points to the user based upon the answer; and
adding the optionally awarded points, if any, to a total awarded points total.

9. The method according to claim 8, further comprising displaying a screen allowing the user to post comments.

10. The method according to claim 8, further comprising displaying a screen allowing the administrator to monitor comments posted by the user.

11. The method according to claim 8, further comprising displaying a screen for allowing the user to view RSS feeds.

12. The method according to claim 8, further comprising displaying a screen for allowing the user to enter identifying information for referring additional users.

13. The method according to claim 8, further comprising displaying a screen allowing the administrator to view the status of each question and all responses to each question.

14. A prediction market system, comprising:
a local interface;
a date store;
a processor coupled to the local interface and the data store, wherein the processor is configured to receive a plurality of prediction questions from an administrator over a communications network, display a first screen whereby a user may chose between a plurality of tabs containing prediction question topics, display a second screen showing the prediction questions, display a third screen showing a single prediction question, upon request by the user, and optionally award points to the user.

15. The prediction market system of claim 14, wherein the processor is configured to display a login screen for allowing a user to provide identifying information.

16. The prediction market system of claim 14, wherein the processor is configured to display a product screen for allowing the user to redeem points optionally awarded for products or services.

17. The prediction market system of claim 14, wherein the processor is configured to display a screen rating the users with the most points.

18. The prediction market system of claim 14, wherein the processor is configured to display a screen allowing users to suggest future questions.

19. The prediction market system of claim 14, wherein the processor is configured to allow the administrator to post prediction questions.

20. The prediction market system of claim 14, wherein the processor is configured to calculate points based upon a predetermined basis involving the accuracy of the answer and the length of time between the date the prediction question is posted to the time the user answers the prediction question.
